(19) United States
(12) Patent Application Publication
(10) Pub. No.: US 2008/0046660 A1
(43) Pub. Date: Feb. 21, 2008

(54) Information recording apparatus and control method thereof

(75) Inventors: Yoriharu Takai, Kodaira-shi (JP); Kenji Yoshida, Akishima-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/878,993

(22) Filed: Jul. 30, 2007

(30) Foreign Application Priority Data
Aug. 18, 2006 (JP) 2006-223256

(51) Int. Cl. G06F 13/38

(52) U.S. Cl. 711/137; 711/E12.016

(57) ABSTRACT

According to one embodiment, a flash memory and an SDRAM having higher information writing and reading speeds are provided as caches with respect to a hard disk. When a free space corresponding to a size of information to be written is not present in the SDRAM and forming in the SDRAM the free space corresponding to the size of the information is predicted, higher one of a speed of writing the information in the SDRAM and a speed of writing the information in the flash memory is determined, and the information is written in a memory having the higher speed.

### CROSS-REFERENCE TO RELATED APPLICATIONS

This application is based upon and claims the benefit of priority from Japanese Patent Application No. 2006-223256, filed Aug. 18, 2006, the entire contents of which are incorporated herein by reference.

### BACKGROUND

1. Field

One embodiment of the present invention relates to an information recording apparatus which writes information in a high-capacity disk type recording medium, e.g., a hard disk through a semiconductor memory, and a control method thereof.

2. Description of the Related Art

As is well known, a hard disk is a reliable high-capacity information recording medium, and is in widespread use for recording, e.g., computer data, video data, audio data, and others in recent years. Further, the hard disk has been reduced in size so that it can be mounted in a portable electronic device.

Therefore, in a downsizing-oriented information recording apparatus using a hard disk, a semiconductor memory capable of writing and reading information at a high speed is used as a cache memory for a hard disk to increase a speed required for writing and reading information.

That is, this type of information recording apparatus enables an external host device to read and write information through a cache memory, and enables a hard disk to transfer information to/from the cache memory, thereby increasing a speed of writing and reading information as seen from the outside.

Furthermore, at the present day, there is an idea of providing a non-volatile memory as a cache with respect to a hard disk in addition to the cache memory to reduce the number of times of driving the hard disk, i.e., the number of times of writing and reading information with respect to the hard disk, thereby saving battery power. Such an information recording apparatus is called an NV (non volatile)-cache compatible HDD (hard disk drive) and standardized.

Meanwhile, as explained above, in the information recording apparatus which includes the non-volatile memory as a cache with respect to the hard disk besides an original cache memory, determining one of the cache memory and the non-volatile memory in which information is to be written upon receiving a request of writing the information from an external host device greatly affects an entire information processing speed including that of the host device.

JP-A 171515-1996 (KOKAI) discloses a memory management scheme in a disk cache of storing volatile data which should be newly written in an NVS region when the disk cache includes a VS (volatile storage) region and an NVS (non volatile storage region and the VS region has no free space whereas the NVS region has a free space.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing an embodiment according to the present invention to explain an outline of an information recording apparatus;

FIG. 2 is a view for explaining recording regions in a flash memory provided in the information recording apparatus according to the embodiment;

FIG. 3 is a block diagram for explaining an example of a controller provided in the information recording apparatus according to the embodiment;

FIG. 4 is a view for explaining reordering processing with respect to a hard disk provided in the information recording apparatus according to the embodiment;

FIG. 5 is a view for explaining the reordering processing with respect to the hard disk provided in the information recording apparatus according to the embodiment;

FIG. 6 is a view for explaining a relationship between an elapsed time and a free region in an SDRAM when moving information from the SDRAM to the hard disk in the information recording apparatus according to the embodiment;

FIG. 7 is a view for explaining a relationship between a written information size and a waiting time until a writable free region is formed in the SDRAM in the information recording apparatus according to the embodiment;

FIG. 8 is a view for explaining a relationship between a writable information size and a waiting time until a writable free region is formed in a flash memory in the information recording apparatus according to the embodiment;

FIG. 9 is a view for explaining judgment processing of determining the SDRAM or the flash memory in which information is to be written in the information recording apparatus according to the embodiment;

FIG. 10 is a flowchart for explaining a part of a primary processing operation in the information recording apparatus according to the embodiment;

FIG. 11 is a flowchart for explaining the remainder of the primary processing operation in the information recording apparatus according to the embodiment;

FIG. 12 is a flowchart for explaining a part of a modification of the primary processing operation in the information recording apparatus according to the embodiment; and

FIG. 13 is a flowchart for explaining the remainder of the modification of the primary processing operation in the information recording apparatus according to the embodiment.

### DETAILED DESCRIPTION

Various embodiments according to the invention will be described hereinafter with reference to the accompanying drawings. In general, according to one embodiment of the invention, a flash memory and an SDRAM having higher information writing and reading speeds are provided as caches with respect to a hard disk. When a free space corresponding to a size of information to be written is not present in the SDRAM and forming in the SDRAM the free space corresponding to the size of the information is predicted, higher one of a speed of writing the information in the SDRAM and a speed of writing the information in the flash memory is determined, and the information is written in a memory having the higher speed.

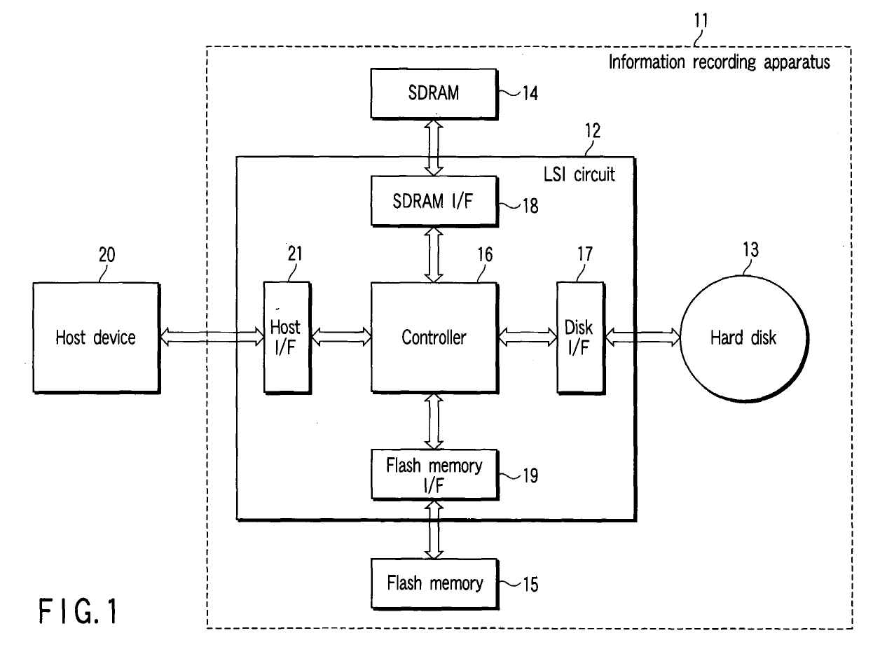

FIG. 1 shows an outline of an information recording apparatus 11 which will be explained in conjunction with this embodiment. As the information recording apparatus 11 explained herein, an NV-cache compatible HDD standardized based on, e.g., Non Volatile Cache Command Proposal for ATA8-ACS revision 5 is a target.

That is, this information recording apparatus 11 includes an one-chip LSI (large scale integrated) circuit 12 having various kinds of built-in circuit blocks. Moreover, a hard disk 13 as a high-capacity disk type recording medium, an SDRAM (synchronous dynamic random access memory) 14, a flash memory 15, and others are connected with this LSI circuit 12.

Of these members, the SDRAM 14 functions as a buffer, and also serves as a cache memory with respect to the hard disk 13. It is to be noted that the present invention is not restricted to the SDRAM and, e.g., an S (static) RAM can be used. Additionally, the flash memory 15 is a non-volatile memory (NV-cache) which functions as a cache with respect to the hard disk 13.

Here, the LSI circuit 12 has a built-in controller 16 serving as a control section which performs overall control when the information recording apparatus 11 executes various kinds of processing operations. Further, this LSI circuit 12 has a built-in disk I/F (interface) 17 which connects the controller 16 with the hard disk 13 to enable information transfer.

Furthermore, this LSI circuit 12 includes an SDRAM I/F 18 which connects the controller 16 with the SDRAM 14 to enable information transfer, a flash memory I/F 19 which connects the controller 16 with the flash memory 15 to enable information transfer, a host I/F 21 which connects the controller 16 with an external host device 20 to enable information transfer, and others.

The host device 20 is, e.g., a PC (personal computer). This host device 20 can utilize the information recording apparatus 11 to execute writing and reading information when executing, e.g., predetermined application software and can also utilize the information recording apparatus 11 as a destination where finally obtained information is stored.

When writing or reading information with respect to the information recording apparatus 11 in this manner, the host device 20 issues a command of requesting the information recording apparatus 11 to write information or a command of requesting the same to read information. These commands are supplied to the controller 16 via the host I/F 21 to be analyzed.

As a result, the controller 16 can control the hard disk 13, the SDRAM 14, the flash memory 15, and others to write information supplied from the host device 20 or read information which is supplied to the host device 20. In this case, the controller 16 can transfer information between the hard disk 13, the SDRAM 14, and the flash memory 15.

Specifically, when writing information fed from the host device 20 in the hard disk 13, the controller 16 can select the following five paths (W1) to (W5) as information writing orders.

(W1) The host I/F 21→the controller 16→the disk I/F 17→the hard disk 13.

(W2) The host I/F 21→the controller 16→the SDRAM I/F 18→the SDRAM 14→the SDRAM I/F 18→the controller 16→the disk I/F 17→the hard disk 13.

(W3) The host I/F 21→the controller 16→the flash memory I/F 19→the flash memory 15→the flash memory I/F 19→the controller 16→the disk I/F 17→the hard disk 13.

(W4) The host I/F 21→the controller 16→the SDRAM I/F 18→the SDRAM 14→the SDRAM I/F 18→the controller 16→the flash memory I/F 19→the flash memory 15→the flash memory I/F 19→the controller 16→the disk I/F 17→the hard disk 13.

(W5) The host I/F 21→the controller 16→the flash memory I/F 19→the flash memory 15→the flash memory I/F 19→the controller 16→the SDRAM I/F 18→the SDRAM 14→the SDRAM I/F 18→the controller 16→the disk I/F 17→the hard disk 13.

Further, when reading information from the hard disk 13 to the host device 20, the controller 16 selects the following five paths (R1) to (R5) as information reading orders.

(R1) The disk I/F 17→the controller 16→the host I/F 21→the host device 20.

(R2) The disk I/F 17→the controller 16→the SDRAM I/F 18→the SDRAM 14→the SDRAM I/F 18→the controller 16→the host I/F 21→the host device 20.

(R3) The disk I/F 17→the controller 16→the flash memory I/F 19→the flash memory 15→the flash memory I/F 19→the controller 16→the host I/F 21→the host device 20.

(R4) The disk I/F 17→the controller 16→the SDRAM I/F 18→the SDRAM 14→the SDRAM I/F 18→the controller 16→the flash memory I/F 19→the flash memory 15→the flash memory I/F 19→the controller 16→the host I/F 21→the host device 20.

(R5) The disk I/F 17→the controller 16→the flash memory I/F 19→the flash memory 15→the flash memory I/F 19→the controller 16→the SDRAM I/F 18→the SDRAM 14→the SDRAM I/F 18→the controller 16→the host I/F 21→the host device 20.

The controller 16 judges and determines the above-described information writing orders and reading orders based on, e.g., instruction contents in a writing request command or a reading request command supplied from the host device 20, a position where information is stored, or a free space in the SDRAM 14 or the flash memory 15.

Here, of various kinds of commands which are set based on the above-explained standard and executable by the information recording apparatus 11, those which are required for explaining this embodiment will be described. First, a first command specifies one of logical block addresses (LBA) in the hard disk 13 which is used to write information in the flash memory 15.

Further, although a second command specifies an LBA which is used to write information in the flash memory 15 like the first command, it requests reading information recorded in the LBA from the hard disk 13 and writing the read information in the flash memory 15.

The first and second commands are associated with PI=0 and PI=1 in Add LBA(s) to NV Cache Pinned Set in the above-explained standard, and attribute information called “pinned” is added to an LBA which is specified by the host device 20 to store information in the flash memory 15.

A third command requests specifying an LBA in the hard disk 13 to write information. When this third command is issued from the host device 20, the controller 16 checks whether pinned attribute information is associated with the LBA requested for writing. Furthermore, when the information is associated, writing is executed in a region corresponding to the LBA requested for writing information in the flash memory 15.

On the other hand, when the pinned attribute information is not associated with the LBA requested for writing, the controller 16 determines to write information in a region corresponding to the specified LBA in the SDRAM 14 or the flash memory 15 or write information at the specified LBA in the hard disk 13 by itself, and executes writing.

A fourth command specifies an LBA in the hard disk 13 to request reading information. In a case where this fourth command is issued from the host device 20, the controller 16 must read from the flash memory 15 information newer than that in the hard disk 13 when a region corresponding to the specified LBA has been already assigned to the flash memory 15 and it is determined that the newer information is stored in this region.

On the other hand, when the hard disk 13 and the flash memory 15 have the same information, the controller 16 may read the information from a region corresponding to an LBA requested for reading in the flash memory 15 or may read the information from a specified LBA in the hard disk 13.

Moreover, when a region corresponding to the specified LBA has been already assigned to the flash memory 15 but the newest data is present in the hard disk 13, the controller 16 must read the information from the specified LBA in the hard disk 13. Additionally, when the information is read from the hard disk 13, the controller 16 determines one of the SDRAM 14 and the flash memory 15 in which the read information is to be cached.

Like the third and fourth commands, attribute information called “unpinned” is added to an LBA whose region is assigned in the flash memory and which has information written in the assigned region in the flash memory among LBAs which are targets of an information writing or reading request and with which pinned attribute information is not associated.

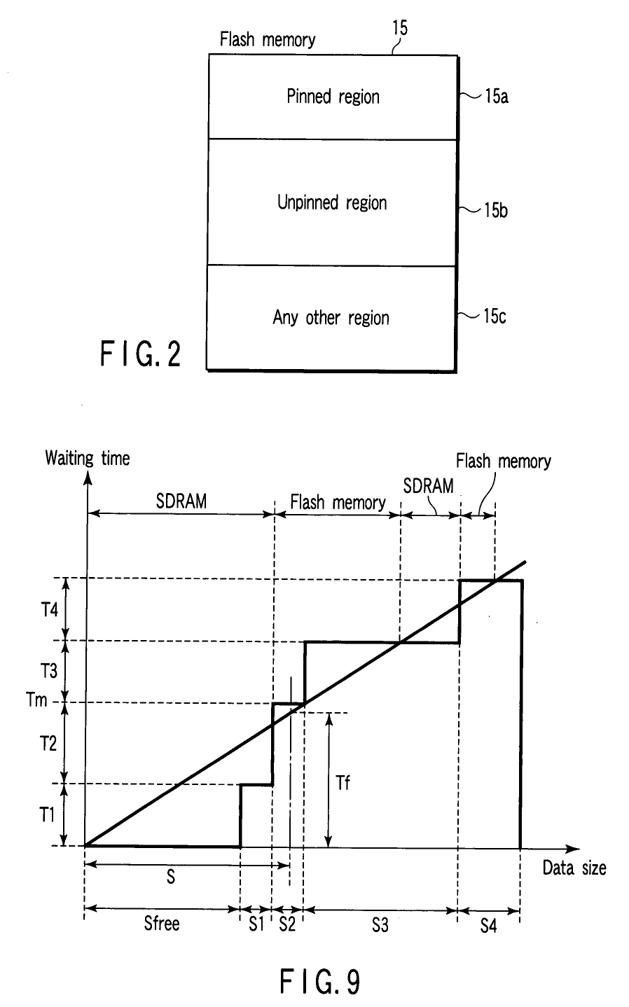

Further, the LBA to which the pinned attributed information is called a pinned LBA, and a region in the flash memory 15 corresponding to this pinned LBA is called a pinned region. Furthermore, the LBA to which the unpinned attribute information is added is called an unpinned LBA, and a region in the flash memory 15 corresponding to this unpinned LBA is called an unpinned region. Therefore, as shown in FIG. 2, a pinned region 15a, an unpinned region 15b, and any other region 15c are formed in the flash memory 15.

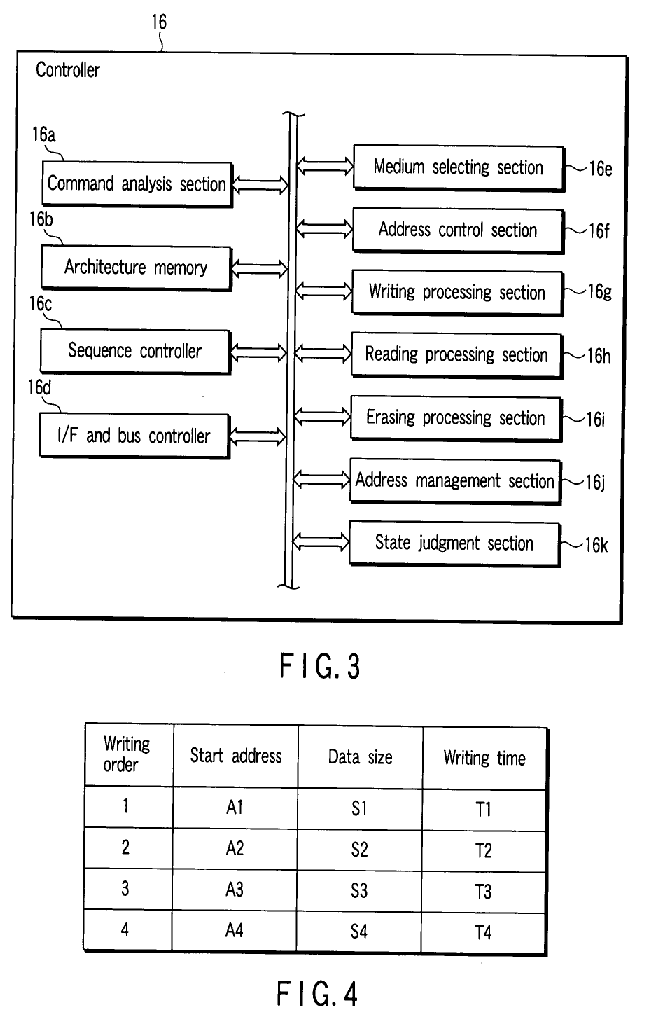

FIG. 3 shows an example of the controller 16. This controller 16 has a command analysis region 16a which decodes and analyzes a command supplied from the host device 20. Based on an analysis result from this command analysis region 16a, software in an architecture memory 16b is specified, and an operation procedure is set in a sequence controller 16c.

This sequence controller 16c controls a flow of information through an I/F and a bus controller 16d. For example, when information is written or read, a medium selecting section 16e specifies the hard disk 13, the SDRAM 14, or the flash memory 15, and an address control section 16f specifies a write address or a read address.

Moreover, when writing information, a writing processing section 16g executes, e.g., transfer processing of writing information. Additionally, when reading information, a reading processing section 16h executes, e.g., transfer processing of reading information.

Further, an erasing processing section 16i is provided in the controller 16. This erasing processing section 16i erases information recorded in the SDRAM 14 or the flash memory 15. Furthermore, this erasing processing section 16i can also erase information recorded in the hard disk 13.

Moreover, an address management section 16j is provided in the controller 16. This address management section 16j collectively manages addresses of, e.g., recorded regions or unrecorded regions in the SDRAM 14, the flash memory 15 and the hard disk 13. Additionally, a state judgment section 16k which monitors, e.g., states of the hard disk 13, the SDRAM 14, and the flash memory 15 or a state of a remaining capacity is provided in the controller 16.

Here, an NAND flash memory is generally extensively is used as the flash memory 15. In this case, a speed of writing information in the flash memory 15 is often slower than a speed of writing information in the SDRAM 14.

Therefore, the controller 16 is designed to selectively execute the following three types of processing (P1) to (P3) when the host device 20 issues a writing request command which specifies an LBA that is out of the range of pinned LBAs.

(P1) When a free space in the SDRAM 14 is larger than an amount of information requested to be written (a data size), the controller 16 controls to write the information requested to be written in the SDRAM 14. In this case, the information requested to be written is transferred to the host device 20, the host I/F 21, the controller 16, the SDRAM I/F 18, and the SDRAM 14 in the mentioned order to be cached in the SDRAM 14, and then transferred to the SDRAM 14, the SDRAM I/F 18, the controller 16, the disk I/F 17, and the hard disk 13 in the mentioned order at an appropriate timing to be stored in the hard disk 13.

(P2) When a free space in the SDRAM 14 is smaller than an amount of information requested to be written but a free space in which the information requested to be written can be written is expected to be formed in the SDRAM 14 because, e.g., information in the SDRAM 14 is moving to the hard disk 13 and when it is figured out that writing can be completed before writing information in the flash memory 15 even if a free space in which the information requested to be written can be written is formed in the SDRAM 14 and then the information is written, the controller 16 controls to write the information requested to be written in the SDRAM 14.

(P3) When a free space in the SDRAM 14 is smaller than an amount of information requested to be written and a free space in which the information requested to be written can be written is not expected to be formed in the SDRAM 14, or when this can be expected but it is figured out that writing the information after the free space in which the information requested to be written can be written is formed in the SDRAM 14 is slower than writing the information in the flash memory 15, the controller 16 controls to write the information requested to be written in the flash memory 15. In this case, the information requested to be written is transferred to the host device 20, the host I/F 21, the controller 16, the flash memory I/F 19, and the flash memory 15 in the mentioned order to be cached in the flash memory 15, and then transferred to the flash memory 15, the flash memory I/F 19, the controller 16, and the disk I/F 17, and the hard disk 13 in the mentioned order at an appropriate timing to be stored in the hard disk 13.

Here, judgment processing in the processing (P2) and (P3) will now be explained. In general, when writing some of a plurality of pieces of information stored in the SDRAM 14 in the hard disk 13, reordering processing is previously carried out with respect to the plurality of pieces of information which should be written to set an order or a timing of writing the information.

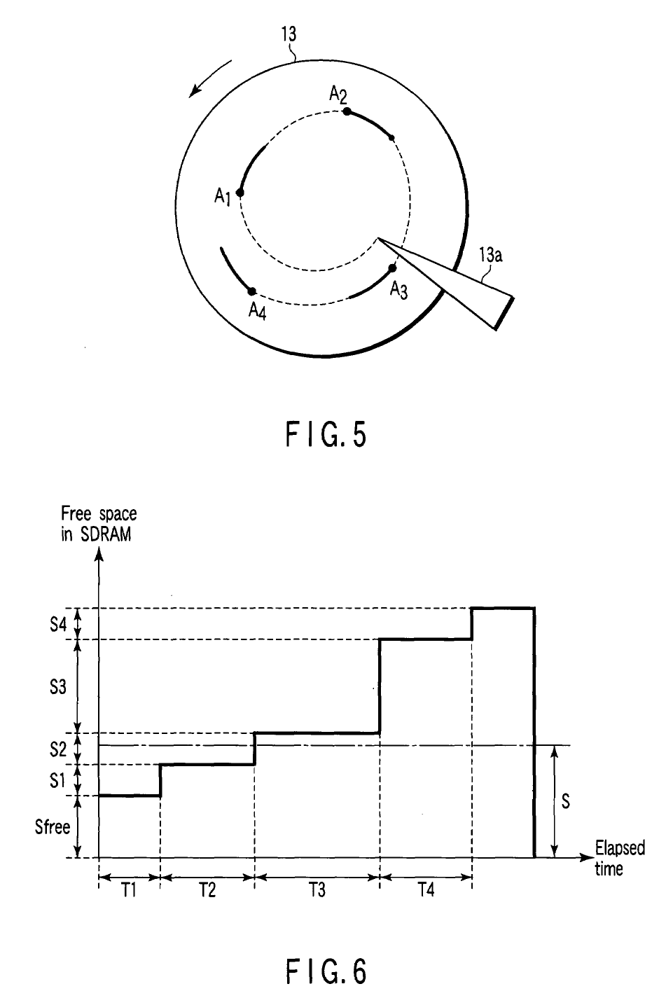

That is, this reordering processing is processing of setting an information writing order in such a manner that the plurality of pieces of information can be efficiently written in the hard disk 13. This processing is realized while considering a writing position of information which should be written in the hard disk 13 (a start address), an information amount (a data size), a position of a current head 13a (see FIG. 5) with respect to the hard disk 13, and others.

FIG. 4 shows a relationship between orders of writing respective pieces of information in the hard disk 13, recording start positions (start addresses) of the respective pieces of information in the hard disk 13, amounts of the respective pieces of information (data sizes), and times required to write the respective pieces of information in the hard disk 13 (write times) about a plurality of (four in the illustrated example) information after the writing order is rearranged by the reordering processing.

Assuming that the hard disk 13 is rotated in a counterclockwise direction as depicted in FIG. 5 and the head 13a moves from an inner peripheral side to an outer peripheral side of the hard disk 13 to write information when an information writing order is set as shown in FIG. 4, it can be understood that the four pieces of information are efficiently written in the hard disk 13.

Further, it can be understood from the relationship depicted in FIG. 4 that writing the information which is the first in the writing order in the hard disk 13 is completed after a time T1 and a vacant region corresponding to a data size S1 is formed in the SDRAM 14 at this moment. Furthermore, writing the information which is the second in the writing order in the hard disk 13 is completed after a time T1+T2 and a free region corresponding to a data size S1+S2 is formed in the SDRAM 14 at this moment.

FIG. 6 shows a relationship between an elapsed time and a free region formed in the SDRAM 14 when a plurality of pieces of information are sequentially written in the hard disk 13 from the SDRAM 14.

Assuming that a free space corresponding to a data size Sfree is present in the SDRAM 14 in advance, it can be understood that a free region corresponding to a data size Sfree+S1 is formed in the DRAM 14 when writing the first information in the hard disk 13 is completed after a time T1, a free region corresponding to a data size Sfree+S1+S2 is formed in the DRAM 14 when writing the second information in the hard disk 13 is completed after a time T1+T2, a free region corresponding to a data size Sfree+S1+S2+S3 is formed in the DRAM 14 when writing the third information in the hard disk 13 is completed after a time T1+T2+T3, and a free region corresponding to a data size Sfree+S1+S2+S3+S4 is formed in the DRAM 14 when writing the fourth (the last) information in the hard disk 13 is completed after a time T1+T2+T3+T4.

Therefore, as indicated by an alternate long and short dash line in FIG. 6, the controller 16 can predict that a free area Sfree+S1+S2 in which information having a data size S of Sfree+S1<S<Sfree+S1+S2 can be written is formed in the SDRAM 14 when the host device 20 issues a request of writing this information.

When the host device 20 issues a request of writing information having a data size larger than a free space which is present in the SDRAM 14 in this manner, the controller 16 predicts that a free space in which the information requested to be written can be written is formed in the SDRAM 14 if information is moving or is to be immediately moved from the SDRAM 14 to the hard disk 13 and a calculation reveals that the free space in which the information requested to be written can be written is formed in the SDRAM 14.

Furthermore, when the controller 16 predicts that the free space allowing writing the information requested to be written from the host device 20 is formed in the SDRAM 14, it compares a speed of writing the information requested to be written in the SDRAM 14 and a speed of writing the same in the flash memory 15.

That is, writing in the SDRAM 14 information having a data size larger than a free space in the SDRAM 14 requires a time obtained by adding a time required to form a free space in which the information requested to be written can be written in the SDRAM 14 to a time required to write the information in the free space formed in the SDRAM 14.

Namely, when the free space in which the information requested to be written can be written is not present in the SDRAM 14, the host device 20 have to wait the above-explained added time. It is to be noted that since the time required to write the information in the SDRAM 14 is greatly shorter than the time required to form the free space in the SDRAM 14, there is no problem in regarding the waiting time of the host device 20 as a time required to form the free space in the SDRAM 14.

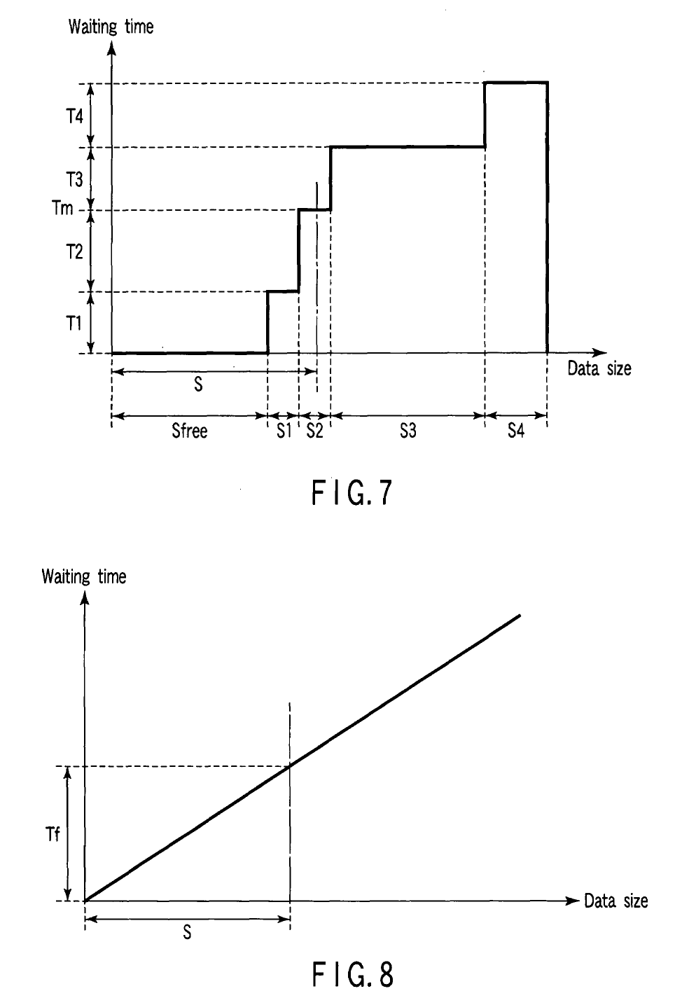

FIG. 7 shows a relationship between a data size of the information requested to be written and a waiting time until the free space in which the information can be written is formed in the SDRAM 14 under conditions that the four pieces of information are moved from the SDRAM 14 to the hard disk 13 as depicted in FIG. 6. For example, in case of information having a data size S of Sfree+S1<S<Sfree+S1+S2, it can be understood that a waiting time of T1+T2 is required at a maximum until a free space Sfree+S1+S2 in which the information can be written is formed in the SDRAM 14. That is, when writing in the SDRAM 14 information having a data size large than a free space in the SDRAM 14, a time Tm required to complete writing this information in the SDRAM 14 is dependent on the data size of the information to be written.

On the other hand, when writing information requested to be written in the flash memory 15, a time of writing the information in the flash memory 15 is required. That is, the host device 20 waits a time required to write in the flash memory 15 the information requested to be written.

Since a recording capacity of the flash memory 15 is much larger than that of the SDRAM 14, the need for assuring a free space is low. That is, when writing information in the flash memory 15, the host device 20 waits a time Tf which is in proportion to a data size S of the information to be written as shown in FIG. 8.

Therefore, the controller 16 compares a time Tm required until writing in the SDRAM 14 information requested to be written is completed with a time Tf required until writing in the flash memory 15 the information requested to be written is completed, and controls to cache the information in the memory having the shorter time. As a result, it is possible to select the SDRAM 14 or the flash memory 15 which can write information requested to be written at the highest speed, thereby increasing an entire information processing speed including that in the host device 20.

FIG. 9 shows superimposition of FIGS. 7 and 8. That is, when the host device 20 issues a request of writing information having a data size larger than a free space in the SDRAM 14 and the controller 16 can predict that a free space in which the information requested to be written can be written is formed in the SDRAM 14, the controller 16 compares the time Tm required until writing the information in the SDRAM 14 is completed with the time Tf required until writing the information in the flash memory 15 is completed. Moreover, the controller 16 controls to write the information in the SDRAM 14 when Tf>Tm and write the information in the flash memory 15 when Tf<Tm.

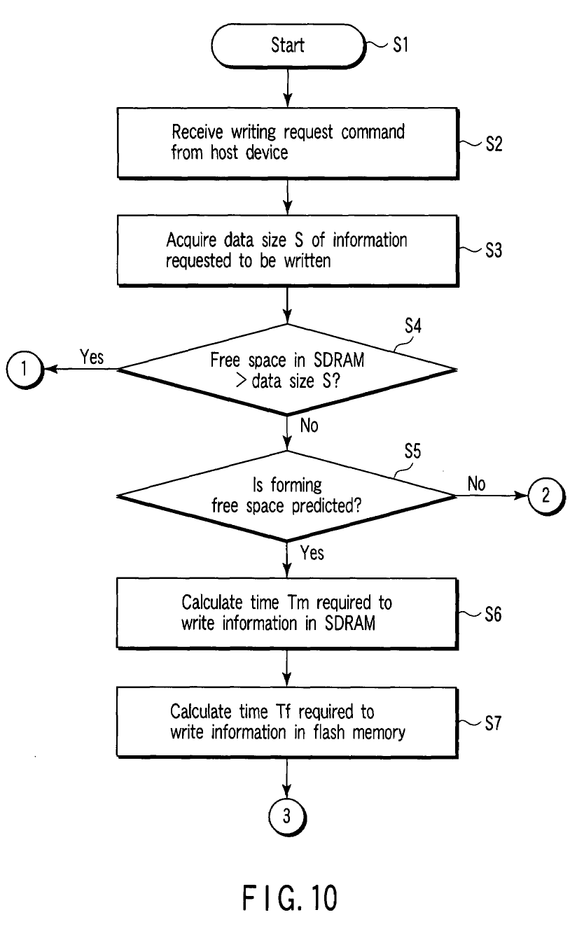

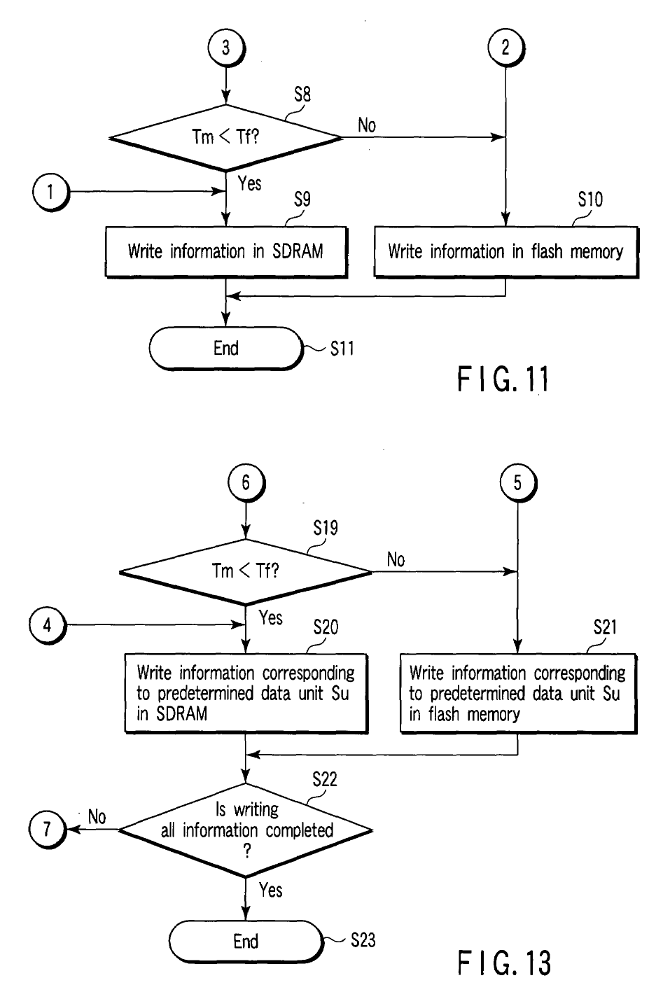

FIGS. 10 and 11 are flowcharts in which processing operations of the controller 16 are summed up. That is, when processing starts (a step S1) and an information writing request command is received from the host device 20 at a step S2, the controller 16 acquires an amount (a data size) S of information requested to be written at a step S3. This data size S is added to the writing request command.

Additionally, the controller 16 judges whether a free space in the SDRAM 14 is larger than the data size S of the information requested to be written at a step S4. If it is determined that the free space is larger (YES), the controller 16 writes the information requested to be written in the SDRAM 14 at a step S9 to terminate the processing (a step S11).

Further, if it is determined that the free space in the SDRAM 14 is not larger than the data size S of the information requested to be written at the step S4 (NO), the controller 16 judges whether predicting that a free space in which the information requested to be written can be written is formed in the SDRAM 14 is possible at a step S5.

Furthermore, if it is determined that predicting that the free space allowing writing the information requested to be written is formed in the SDRAM 14 is impossible (NO), the controller 16 writes the information requested to be written in the flash memory 15 at a step S10 to terminate the processing (a step S11).

Moreover, if it is determined that predicting that the free space allowing writing the information requested to be written is formed in the SDRAM 14 is possible at the step S5 (YES), the controller 16 calculates a time Tm required until writing in the SDRAM 14 the information requested to be written is completed at a step S6. Additionally, the controller 16 calculates a time Tf required until writing in the flash memory 15 the information requested to be written is completed at a step S7.

Further, the controller 16 compares the time Tm with the time Tf, and judges whether the time Tm is shorter than the time Tf, i.e., whether the time Tm<the time Tf is achieved at a step S8. If it is determined that the time Tm<the time Tf is achieved (YES), the controller 16 writes in the SDRAM 14 the information requested to be written at a step S9 to terminate the processing (the steps S11).

Furthermore, if it is determined that the time Tm<the time Tf is not achieved at the step S8 (NO), the controller 16 writes in the flash memory 15 the information requested to be written at a step S10 to terminate the processing (the step S11).

According to the embodiment, when a free space allowing storing information requested to be written is not present in the SDRAM 14, the controller 16 judges whether predicting that the free space allowing storing the information requested to be written is formed in the SDRAM 14 is possible. If prediction is possible, the controller 16 writes the information in one of the SDRAM 14 and the flash memory 15 which has a shorter time required until writing the information is completed.

Therefore, either the SDRAM 14 or the flash memory 15 in which information requested by the host device 20 to be written can be written at the highest speed can be readily and rapidly selected, thereby increasing a speed of an entire information processing speed including that in the host device 20.

A modification of the embodiment will now be explained. That is, information requested by the host device 20 to be written may be divided in predetermined data units (e.g., units of data to be written in the flash memory 15), and a writing speed in the SDRAM 14 may be compared with that in the flash memory 15 in accordance with each data unit to write the information.

When this configuration is adopted, the number of times of performing arithmetic operations for judgments is increased. However, since either the DRAM 14 or the flash memory 15 in which information is to be written is determined in accordance with each predetermined data unit, it is possible to effectively cope with a foreign element which occurs after the host device 20 issues the writing request command.

For example, it is assumed that the host device 20 issues a writing request command, forming in the SDRAM 14 a free space allowing storage of information to be written can be predicted, and the controller 16 determines that writing the information in the SDRAM 14 is faster than writing the same in the flash memory 15. Even in such a case, a writing error may occur due to, e.g., external vibrations during writing the information in the hard disk 13 from the SDRAM 14, and a time longer than an expected time may be required until the necessary free space is formed in the SDRAM 14.

On the other hand, determining either the DRAM 14 or the flash memory 15 where the information is to be written in accordance with each predetermined data unit enables sufficiently coping with such an unexpected situation.

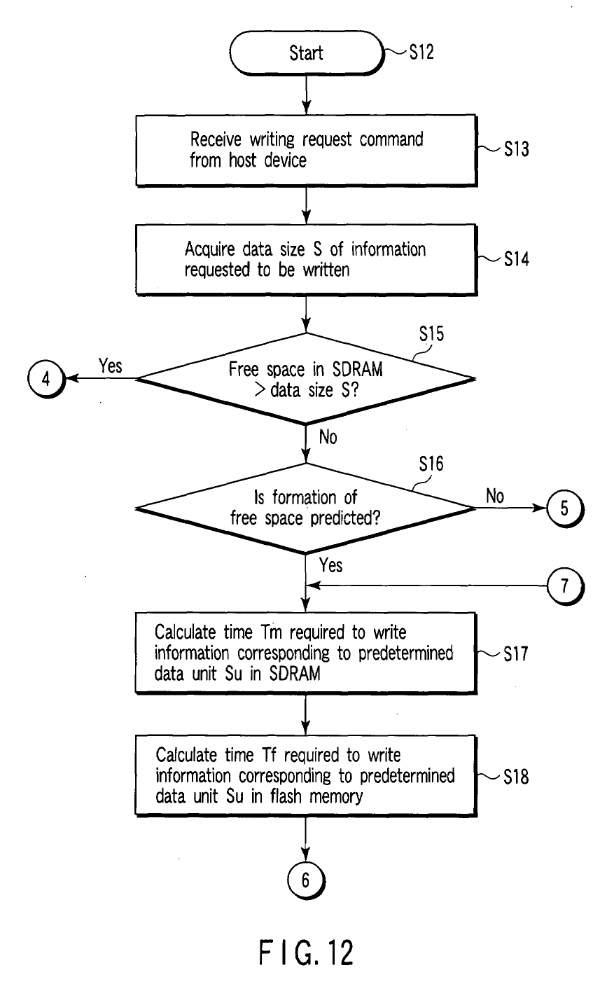

FIGS. 12 and 13 are flowcharts in which processing operations of the controller 16 which divides information requested by the host device 20 to be written in predetermined data units and determines either the DRAM 14 or the flash memory 15 in accordance with each data unit are summed up. That is, when processing starts (a step S12) and an information writing request command is received from the host device 20 at a step 13, the controller 16 acquires an amount (a data size) S of information requested to be written at a step S14.

Moreover, the controller 16 judges whether a free space in the SDRAM 14 is larger than the data size S of the information requested to be written at a step S15. If it is determined that the free space is larger (YES), the controller 16 writes in the SDRAM 14 the information requested to be written corresponding to a predetermined data unit Su at a step S20.

Then, the controller 16 judges whether writing all divided pieces of the information requested to be written is completed at a step S22. If it is determined that writing is completed (YES), the controller 16 terminate the processing (a step S23).

Further, if it is determined that the free space in the SDRAM 14 is not larger than the data size S of the information requested to be written at the step S15 (NO), the controller 16 judges whether forming the free space allowing writing the information requested to be written in the SDRAM 14 can be predicted at a step S16.

Furthermore, if it is determined that forming the free space allowing writing the information requested to be written in the SDRAM 14 cannot be predicted (NO), the controller 16 writes the information requested to be written corresponding to a predetermined data unit Su in the flash memory 15 at a step S21 and advances to processing at a step S22.

Moreover, if it is determined that forming in the SDRAM 14 the free space allowing writing the information requested to be written can be predicted (YES) at the step S16, the controller 16 calculates a time Tm required until writing in the SDRAM 14 the information requested to be written corresponding to the predetermined data unit Su is completed at a step S17. Additionally, the controller 16 calculates a time Tf required until writing in the flash memory 15 the information requested to be written corresponding to the predetermined data unit Su is completed at a step S18.

Further, the controller 16 compares the time Tm with the time Tf at a step S19, and judges whether the time Tm is shorter than the time Tf, i.e., whether the time Tm<the time Tf is achieved. If it is determined that the time Tm<the time Tf is achieved (YES), the controller 16 writes in the SDRAM 14 the information requested to be written corresponding to the predetermined data unit Su at a step S20 and advances to the processing at the step S22.

Furthermore, if it is determined that the time Tm<the time Tf is not achieved at the step S19 (NO), the controller 16 writes in the flash memory 15 the information requested to be written corresponding to the predetermined data unit Su at the step S21 and advances to the processing at the step S22. Moreover, if it is determined that writing all of the information requested to be written is not completed at the step S22 (NO), the controller 16 shifts to the processing at the step S17.

According to the modification, the information requested to be written by the host device 20 is divided in the predetermined data units Su, and a speed or writing the information in the SDRAM 14 is compared with that in the flash memory 15 in accordance with each data unit Su to determine the higher speed. Therefore, it is possible to sufficiently cope with an unexpected situation, e.g., a foreign element which occurs after the writing request command is issued from the host device 20 and readily and rapidly select either the SDRAM 14 or the flash memory 15 in which the information requested to be written can be written at the highest speed. Additionally, an entire information processing speed including a speed of the host device 20 can be increased.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information recording apparatus comprising:
a disk type recording medium;
a non-volatile memory which serves as a cache with respect to the disk type recording medium;
a cache memory which has information writing and reading speeds higher than those of the non-volatile memory and serves as a cache with respect to the disk type recording medium;
a judgment section which judges whether forming in the cache memory a free space corresponding to a size of information requested to be written is predicted when a request of writing the information at an address other than an address where writing in a corresponding region in the non-volatile memory is requested is issued and the free space corresponding to the size of the information requested to be written is not present in the cache memory; and
a control section which determines higher one of a speed of writing the information requested to be written in the cache memory and a speed of writing the information requested to be written in the non-volatile memory and writes the information in a memory having the higher speed, when the judgment section determines that forming in the cache memory the free space corresponding to the size of the information requested to be written is predicted.

2. The apparatus according to claim 1,
wherein the judgment section determines that forming in the cache memory the free space corresponding to the size of the information requested to be written is predicted when information corresponding to the size of the information requested to be written which is formed in the cache memory is moving from the cache memory to the disk type recording medium or when it is clear that the information is to be moved.

3. The apparatus according to claim 1,
wherein the judgment section judges whether forming in the cache memory the free space corresponding to the size of the information requested to be written is predicted based on a result of reordering processing of setting an order of writing each information in the cache memory to the disk type recording medium when a plurality of pieces of information are moved from the cache memory to the disk type recording medium.

4. The apparatus according to claim 1,
wherein the control section compares a time required to write in the cache memory the information requested to be written with a time required to write in the non-volatile memory the information requested to be written, and writes the information in a memory having the shorter time required to write the information.

5. The apparatus according to claim 4,
wherein the control section sets a time required to write in the cache memory the information requested to be written based on a result of reordering processing of setting an order of writing in the disk type recording medium each information in the cache memory when moving a plurality of pieces of information from the cache memory to the disk type recording medium.

6. The apparatus according to claim 1,
wherein the control section divides the information requested to be written in predetermined data units, compares a speed of writing the information in the cache memory with a speed of writing the information in the non-volatile memory in accordance with each data unit, and writes the information in a memory having the higher speed in accordance with each data unit.

7. The apparatus according to claim 1,
wherein the control section performs the following operations:
writing in the cache memory the information requested to be written when the free space corresponding to the size of the information requested to be written is present in the cache memory; and
writing in the non-volatile memory the information requested to be written when the judgment section determines that forming the free space corresponding to the size of the information to be written in the cache memory is not predicted.

8. The apparatus according to claim 1,
wherein the disk type recording medium includes a hard disk, the cache memory includes one of an SDRAM, a DRAM, and an SDRAM, and the non-volatile memory includes an NAND flash memory.

9. A control method of an information recording apparatus which is a method of controlling an information recording apparatus including: a disk type recording medium; a non-volatile memory serving as a cache respect to the disk type recording medium; and a cache memory having information writing and reading speeds higher than those of the non-volatile memory and serving as a cache with respect to the disk type recording medium, the method comprising:
judging whether a free space corresponding to a size of information requested to be written is present in the cache memory when a request of writing the information at an address other than an address where writing the information in a corresponding region in the non-volatile memory is requested is issued;
judging whether forming in the cache memory the free space corresponding to the size of the information requested to be written is predicted when it is determined that the free space corresponding to the size of the information requested to be written is not present in the cache memory; and
determining higher one of a speed of writing in the cache memory the information requested to be written and a speed of writing in the non-volatile memory the information requested to be written and writing the information in a memory having the higher speed, when it is determined that forming in the cache memory the free space corresponding to the seize of the information requested to be written is predicted.

10. The method according to claim 9,
wherein judging whether forming in the cache memory the free space corresponding to the size of the information requested to be written is predicted determines that forming in the cache memory the free space corresponding to the size of the information requested to be written is predicted, when information corresponding to forming in the cache memory the free space corresponding to the size of the information requested to be written is moving from the cache memory to the disk type recording medium or when it is known that the information is to be moved.

11. The method according to claim 9,
wherein, when moving a plurality of pieces of information from the cache memory to the disk type recording medium, judging whether forming in the cache memory the free space corresponding to the size of the information requested to be written is predicted judges whether forming in the cache memory the free space corresponding to the size of the information to be written is predicted based on a result of reordering processing of setting an order of writing in the disk type recording medium each information in the cache memory.

12. The method according to claim 9,
wherein determining higher one of a speed of writing in the cache memory the information requested to be written and a speed of writing in the non-volatile memory the information requested to be written and writing the information in a memory having the higher speed compares a time required to write in the cache memory the information requested to be written with a time required to write in the non-volatile memory the information requested to be written, and writes the information in the memory having the shorter time required to write the information.

13. The method according to claim 12,
wherein, when moving a plurality of pieces of information from the cache memory to the disk type recording medium, determining higher one of a speed of writing in the cache memory the information requested to be written and a speed of writing in the non-volatile memory the information requested to be written and writing the information in a memory having the higher speed sets a time required to write in the cache memory the information requested to be written based on a result of reordering processing of setting an order of writing in the disk type recording medium each information in the cache memory.

14. The method according to claim 9,
wherein determining higher one of a speed of writing in the cache memory the information requested to be written and a speed of writing in the non-volatile memory the information requested to be written and writing the information in a memory having the higher speed divides the information requested to be written in predetermined data units, determines higher one of a speed of writing the information in the cache memory and a speed of writing the information in the non-volatile memory in accordance with each data unit, and writes the information in a memory having the higher speed in accordance with each data unit.
